(19) United States
(12) Patent Application Publication
(10) Pub. No.: US 2002/0125096 A1
(43) Pub. Date: Sep. 12, 2002

(54) Electromagnetic wet clutch system

(75) Inventors: Nobushi Yamazaki, Tochigi-shi (JP); Masaaki Fusegi, Tochigi-shi (JP); Tetsushi Tomita, Tochigi-shi (JP)

Correspondence Address: David L. Fehrman, Morrison & Foerster LLP, 35th Floor, 555 W. 5th Street, Los Angeles, CA, 90013, US

(73) Assignee: TOCHIGI FUJI SANGYO KABUSHIKI KAISHA, Tochigi-shi (JP)

(21) Appl. No.: 10/094,088

(22) Filed: Mar. 8, 2002

(30) Foreign Application Priority Data
Mar. 8, 2001 (JP) 2001-064752
Jun. 27, 2001 (JP) 2001-194892

(51) Int. Cl. F16D 27/12

(52) U.S. Cl. 192/35; 192/84.7; 192/84.91

(57) ABSTRACT

An electromagnetic wet clutch system includes operation members configured to magnetically work. The system includes a set of clutch plates configured to engage by the operation members. The set of clutch plates includes first plates with first sides. Respective one of the first sides is configured to contact respective one of the operation members. At least one of the first sides is boundary-lubricative.

### BACKGROUND OF THE INVENTION

The invention relates to an electromagnetic wet clutch system.

A conventional coupling includes a rotary casing, an inner shaft, a primary clutch, a ball cam, a pressure plate, a cam ring, a pilot clutch, an armature, and an electromagnet.

The pilot clutch includes a multi-plate clutch of inner and outer plates. The multi-plate clutch is formed with lubrication grooves or is nitrided under a gas atmosphere or a salt-bath thereon. Neighboring inner and outer plates have air gaps of lubrication grooves or surface treatment layers (nitrided film) therebetween.

### SUMMARY OF THE INVENTION

The air gaps or layers, however, interfere or reduce the magnetic force of the electromagnet, thus deteriorating magnetic flux efficiency. The deterioration lowers the force of attraction to the armature.

Specifically, both sides of the inner and outer plates are formed with the lubrication grooves or a surface treatment layers. Between an outer plate and the armature or the rotor, the air gaps of lubrication grooves or surface treatment layers cause loss of magnetic flux. This loss deteriorates magnetic flux efficiency.

The present invention is directed to an electromagnetic wet clutch system with improved clutch plates durability.

The present invention is directed to one with improved magnetic flux efficiency.

The invention includes an electromagnetic wet clutch system. The system includes operation members configured to magnetically work. The system includes a set of clutch plates configured to engage by the operation members. The set of clutch plates includes first plates with first sides. Respective one of the first sides is configured to contact respective one of the operation members. At least one of the first sides is boundary-lubricative.

According to the system, an operation member with a stable sectional area of magnetic path contacts a boundary-lubricative first side with air gaps for boundary-lubrication. This allows maximum magnetic permeability, thus further improving magnetic flux efficiency.

The term of “boundary lubricative” means that a side includes minute projections and recesses, surface roughness and a basic roughness remaining due to the formation into a plate shape by pressing. The projections and recesses are not limited by a rotational and a radial direction, a dotted state and length. The term means that a surface structure of the side is essentially boundary lubricative.

The operation members include, for example, an armature and a rotor.

Preferably, the set of clutch plates comprises a second plate disposed between the first plates. The second plate including inner and outer peripheries defines a second side therebetween. The second side defines a hydraulic passage extends between the inner and outer peripheries. According to the system, the hydraulic passage on the second side allows secure lubrication and cooling, thus preventing wearing and seizing.

Preferably, the second plate includes a boundary-lubricative second opposite side relative to the second side. According to the system, the combination of first and second plates improves magnetic flux efficiency, which increases engagement torque of the system.

Preferably, the second plate includes a second opposite side relative to the second side, the second opposite side defining a hydraulic passage.

Preferably, the hydraulic passage extends radially. This system enhances the hydraulic circulation on the second side, thus further improving cooling exertion. The preference allows the hydraulic fluid to be retained quickly and uniformly on a boundary-lubricative first side.

Preferably, a boundary-lubricative first plate is configured to rotate integrally with an operation member. This system further prevents variation of air gaps and increases the magnetic path in the surface area, thus improving magnetic flux efficiency. The first side or a contact side requires no hardening treatment such as a heat treatment, thus allowing improvement in magnetic flux efficiency and reduction in fuel costs.

Preferably, the first plate and the operation member connect to a common spline.

Preferably, the set of clutch plates includes a pair of sides sliding each other. One of said pair of sides includes a hydraulic passage. Another of said pair of sides is boundary-lubricative. According to the preference, the loss of magnetic permeability due to the hydraulic passage on the one side allows the loss of magnetic force to be limited to a minimum.

Preferably, the set of clutch plates is disposed between inner and outer rotary members. The inner and outer rotary members have a fluid sealed therebetween for lubricating the set of clutch plates. According to the system, within a limited space between the inner and outer rotary members, the lubrication, cooling and magnetic flux efficiency of the system improve. The system has large torque capacity of clutch engagement, with less variation per time and excellent durability.

### BRIEF DESCRIPTION OF THE ACCOMPANYING DRAWINGS

These and other features, aspects, and advantage of the present invention will become better under stood with reference to the following description, appended claims, and accompanying drawings where:

FIG. 1 is a sectional view of a coupling according to the first embodiment of the invention;

FIG. 2 is an enlarged sectional view of a pilot multi-plate clutch in FIG. 1;

FIG. 3 is a perspective view of inner and outer plates in FIG. 1;

FIG. 4 is a perspective view of inner and outer plates according to the second embodiment;

FIG. 5 is a perspective view of inner and outer plates according to the third embodiment;

FIG. 6 is an exploded sectional view of a multi-plate clutch according to the fourth embodiment;

FIG. 7 is a perspective view of inner and outer plates of the multi-plate clutch in FIG. 6; and

FIG. 8 is a perspective view of inner and outer plates of the multi-plate clutch according to the fifth embodiment.

### DETAILED DESCRIPTION OF THE PREFERRED EMBODIMENTS

The embodiments of the invention will be described with reference to drawings.

[First Embodiment]

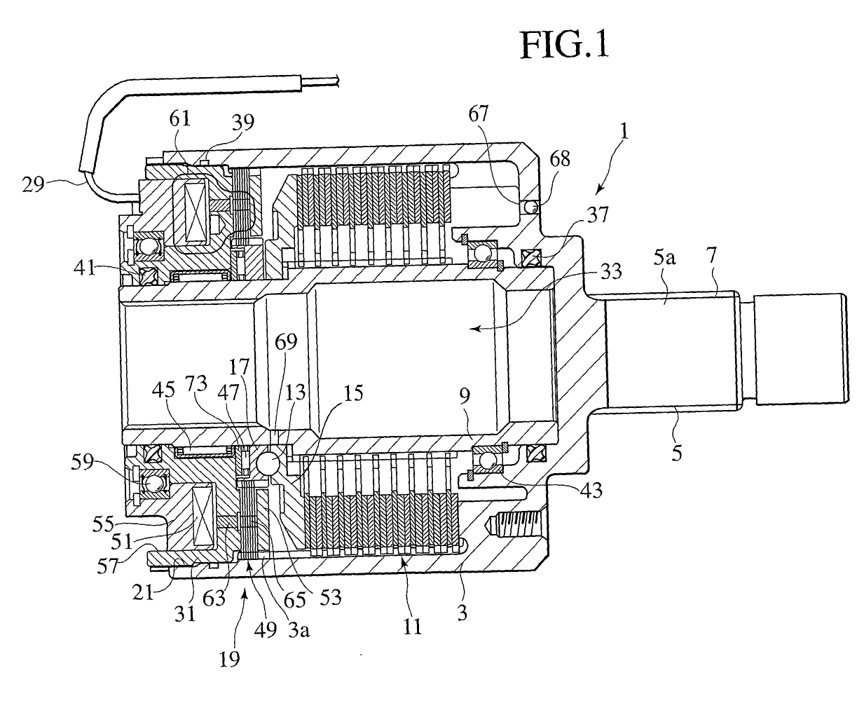

As shown in FIG. 1, coupling 1 is disposed between a rear differential to be separated and an engine (transfer). The left of FIG. 1 corresponds to the front (engine) of a vehicle.

Whole coupling 1 is housed in a casing (not shown in FIGS.) fixed to the vehicle body. Coupling 1 includes clutch housing 3 or an outer rotary member. Coupling 1 includes clutch hub 9 or an inner rotary member in clutch housing 3. Disposed between clutch housing 3 and clutch hub 9 are primary clutch 11, ball cam 13, pressing member 15, cam ring 17, and pilot clutch 19.

Clutch housing 3 of a magnetic steel is configured in a cylindrical shape as a whole. The front part of the housing connects to power transmission shaft 5. The rear part of the housing has opening 21 provided thereto.

Shaft 5 is made of a magnetic steel for a shaft. The external face 5a of the shaft is formed with serration 7 for serration connection with a companion flange (not shown in FIGS.). The companion flange connects to a flange of a propeller shaft to connect to the engine (transfer).

Mounted to opening 21 is ring-shaped magnetic rotor 31 to rotate integrally with housing 3. Shaft 5, housing 3 and rotor 31 are integral with each other. They 5, 3, 31 are supported to a casing of a vehicle by bearings (not shown) on shaft 5 and rotor 31.

Clutch hub 9 is disposed within housing 3. The front end thereof is supported to housing 3 by ball bearing 43. Hub 9 connects to a drive pinion shaft of the rear differential.

Multi-plate primary clutch 11 is disposed between housing 3 and hub 9. Ball cam 13 is disposed between pressing member 15 and cam ring 17. Ball cam 13 and cam ring 17 constitute a cam mechanism.

Pressing member 15 is splined axially movably to hub 9. Ball cam 13 presses primary clutch 11 to be engaged under a thrust force.

Cam ring 17 is disposed on the outer peripheral face of hub 9. Disposed between cam ring 17 and rotor 31 is thrust bearing 47 against the cam repulsion of ball cam 13.

Pilot clutch 19 includes multi-plate clutch 49. The clutch 49 is disposed between housing 3 and cam ring 17. Armature 53 is disposed proximate to the front of clutch 49. The armature is connected to a spline 3a of housing 3. The spline 3a is also connected with outer plates 75A. Armature 53 may be splined to hub 9.

Rotor 31 is operated by electromagnet 51. Inserted with some play in recess 57 of rotor 31 is yoke 55 of electromagnet 51. Rotor 31 is supported rotatably to yoke 55 by seal bearing 59.

Electromagnet 51 is fixed to the casing of the vehicle body. Electromagnet 51 connects to a battery via lead wire 29. The operation of magnetization or demagnetization is controlled by a controller.

Rotor 31, clutch 49 and armature 53 define line 61 of magnetic force (path of magnetic flux) from electromagnet 51.

Disposed in rotor 31 is ring 63 of non-magnetic stainless steel. The ring prevents the magnetic flux 61 of magnetic force from escaping. Clutch 49 includes notch 65 located in correspondence with ring 63. Notch 65 prevents the magnetic flux 61 of magnetic force from escaping and leaking.

Disposed between thrust bearing 47 and rotor 31 is spacer 73 of a washer. Spacer 73 is made of non-magnetic material such as aluminum or stainless steel. The spacer 73 prevents the leakage of the magnetic flux 61 of electromagnet 51 to cam ring 17.

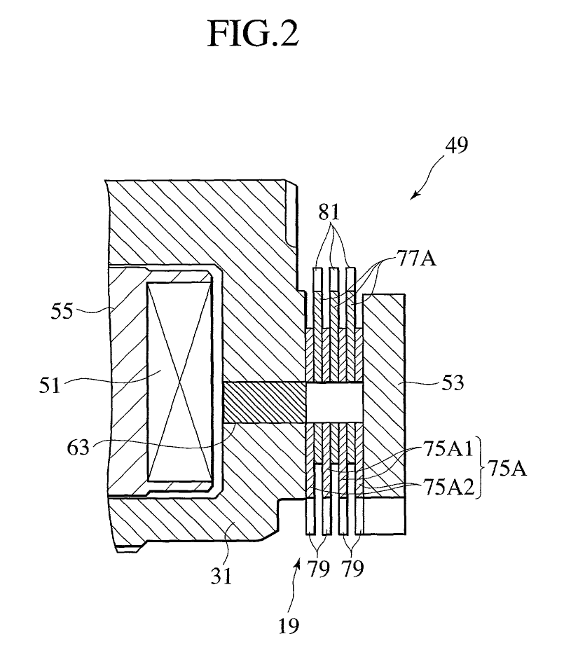

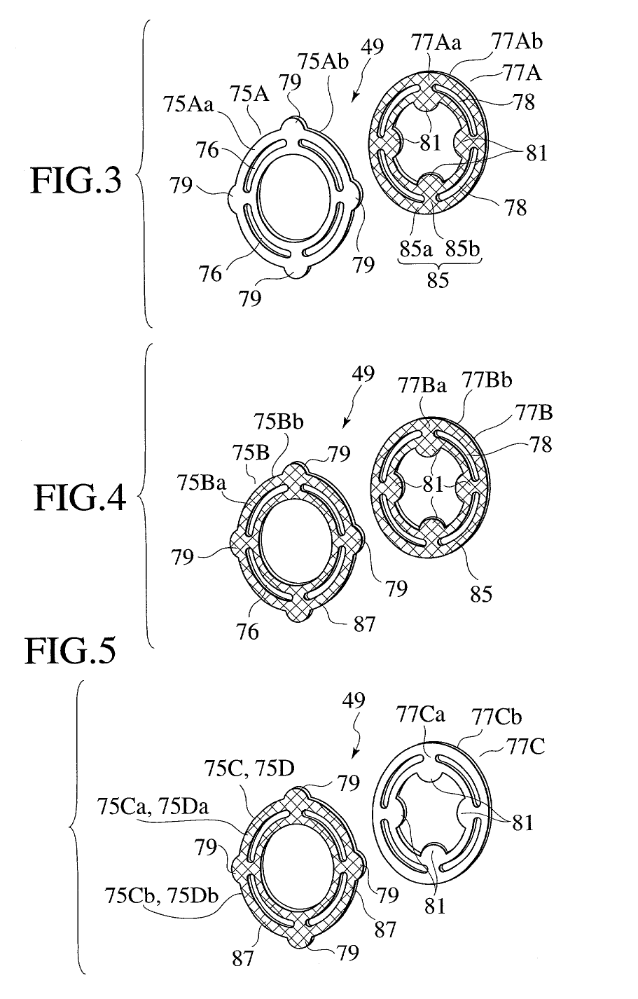

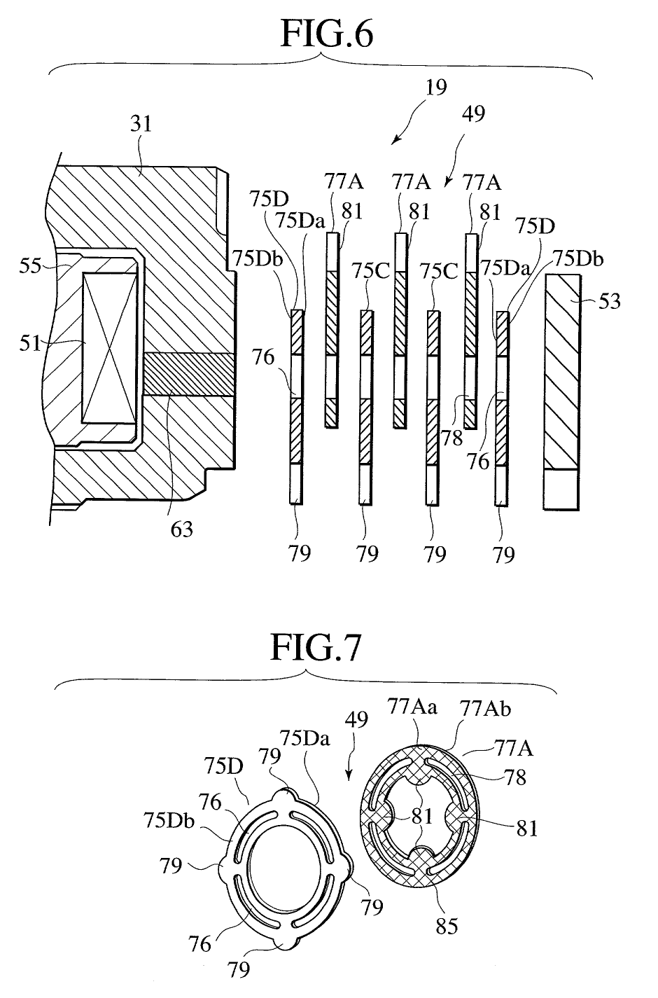

Clutch 49, as shown in FIGS. 2 and 3, includes, for example, four outer plates 75A and three inner plates 77A alternately stacked on each other. As to the stack, outer plates 75A2 are located at both ends of clutch 49. The arrangement allows inner plates 77A to be interposed between outer plates 75.

Outer plates 75A are splined to housing 3. Inner plates 77A are splined to cam plate 17. For the achievement of spline connection, the outer periphery of each outer plate 75A includes arc-shaped engagement lugs 79 formed at angular intervals of 90 degrees. The inner periphery of each inner plate 77A includes arc-shaped engagement lugs 81 formed at angular intervals of 90 degrees. Each plate 75A, 77A includes four arc-shaped holes 76, 78 for hydraulic lubrication therethrough.

Neighboring plates 75A, 77A slide against each other. Formed on plate 77A are lubrication grooves 85 for hydraulic lubrication.

Lubrication grooves 85 are formed on one of sliding sides 75Ab, 77Aa. In FIG. 3, both sides 77Aa and 77Ab of each inner plate 77A of the embodiment are formed with lubrication grooves 85. The grooves include narrow grooves 85a and 85b on the both sides 77Aa, 77Ab of inner plate 77A. Grooves 85a, 85b transversely extend between the inner and outer peripheries of inner plate 77A. Grooves 85a, 85b cross each other at an angle of, for example, 90 degrees. The radial component of each of the grooves 85a, 85b circulates a lubrication oil from the inside to the outside of inner plate 77A. The tangential component of each groove 85a, 85b retains a lubrication oil.

The both sides 75Aa, 75Ab of outer plate 75A are flattened without lubrication grooves. The flatting includes a minute unevenness at a surface roughness less than 10 im.

The combination of outer plate 75A and inner plate 77A negate an air gap therebetween, the side of outer plate 75A facing armature 53 being without lubrication grooves. On the other hand, inner plates 77A, being interposed between outer plates 75A, slide against outer plates 75A. Thus, the formation of lubrication grooves is limited to a necessary minimum. This reduces air gaps due to the lubrication grooves 85. The reduction prevents reduction in magnetic force, thus improving magnetic flux efficiency.

In the structure, electromagnet 51 attracts armature 53 along magnetic flux 61 of magnetic force when magnetizing. The armature presses and engages clutch 49. The engagement produces a pilot torque. The pilot torque allows a driving force of the engine to be applied to ball cam 13 through housing 3, clutch 49, and cam ring 17. The thrust force of the cam allows pressing member 15 to press and engage primary clutch 11 under a thrust force. The engagement allows coupling 1 to be connected.

The connection of coupling 1 allows the rear differential to be connected to the engine. The connection reduces the vehicle to four-wheel drive. At this time, the control of the magnetic force of electromagnet 51 in magnitude by a controller allows the pilot torque of clutch 49 to be changed due to sliding. The change allows thrust force of ball cam 13 to be changed. The change allows connecting force of primary clutch 11 and coupling 1 to be adjusted.

The adjustment of the connecting force of coupling 1 allows the torque distribution ratio between front and rear wheels of the vehicle to be adjusted.

When electromagnet 51 demagnetizes, the pilot torque of clutch 49 disappears. The disappearance allows primary clutch 11 to be disengaged. The disengagement allows coupling 1 to be disconnected. The disconnection of coupling 1 allows the rear differential to be separated from the shaft 5. The vehicle becomes a two-wheel drive with front-wheel drive.

An oil is poured into shaft 5, housing 3 and rotor 31 through oil hole 67 provided to housing 3. After pouring the oil, ball 68 seals oil hole 67.

Disposed between housing 3 and hob 9 is X-ring 37. Between the housing 3 and rotor 31, O-ring 39 is disposed. Between rotor 31 and hub 9, X-ring 41 is disposed. The respective rings prevent the leakage of oil to the outside.

The sealed oil is stored in oil reservoir 33 provided to hub 9. Hub 9 has radial oil passage 69 in communication with reservoir 33. When hub 9 rotates, the oil flows from reservoir 33 through passage 69. The oil lubricates primary clutch 11 and ball bearing 43. In addition, the oil lubricates ball cam 13, thrust bearing 47, clutch 49, X-rings 37, 41.

In the above-embodiment, the both sides 77Aa, 77Ab of inner plates 77A are formed with lubrication grooves 85. Both sides of each outer plates 75A are formed without lubrication grooves. Inner plates 77A, being interposed between outer plates 75A slide against outer plates 75A,. The formation allows grooves 85 to be limited to a necessary minimum. The formation of grooves 85 reduces air gaps needed to be produced. This reduction prevents the lowering of magnetic force, thus improving magnetic flux efficiency.

The improvement of magnetic flux efficiency allows magnetic flux to be guided efficiently to armature 53, thus obtaining pilot torque by clutch 49.

The loss of exciting power to electromagnet 51 reduces remarkably. The reduction reduces load of a battery, thus improving fuel costs of the engine. The electromagnet 51 is small-sized, and the whole coupling 1 becomes lighter and more compact.

The formation of lubrication grooves 85 on the both sides 77Aa, 77Ab of all inner plates 77A allows for their use as common inner plate components.

FIG. 4 shows the second embodiment. Corresponding identical members to the first embodiment are attached with identical reference characters. The description omits repetition.

[Second Embodiment]

The second embodiment differs in the formation of lubrication grooves and is identical to the first embodiment in other structures.

Respective inner and outer plates 77B, 75B include lubrication grooves 85, 87 formed on one side 77Ba, 75Ba thereof. The opposite side 77Bb, 75Bb are flattened without lubrication grooves. The sides 77Ba, 75Ba with lubrication grooves 85, 87 contact with the neighboring flat sides 75Bb, 77Bb, thus allowing the stacking of outer and inner plates 77B, 75B each other.

According to the stacked plates, lubrication grooves are not provided to both of facing sides 77Bb and 75Ba or 77Ba and 75Ab of neighboring plates, but to one of the facing sides (one side) 77Ba and 75Ba for hydraulic lubrication. The formation of lubrication grooves on one side 77Ba, 75Ba at siding portions allows the lubrication grooves to be limited to a necessary minimum. This reduces air gaps produced due to the formation of lubrication grooves 85, 87. This reduction prevents the lowering of magnetic force, thus improving magnetic flux efficiency.

[Third Embodiment]

The third embodiment will be described with reference to FIG. 5. The third embodiment has outer plates 75C of clutch 49 formed with lubrication grooves.

Outer plates 75C are stacked on neighboring inner plates 77C and are located in the middle of the stacked plates. Both sides 75Ca, 75Cb of outer plates 75C are formed with lubrication grooves 87. Another outer plates 75D are located at both ends in the stacked plates. The outer plates 75D each have lubrication grooves 87 on a side 75Da facing inner plate 77C. The opposite side 75Db thereof is flat without a lubrication groove. The flat sides 75Db face armature 53 and rotor 31 to rotate integrally with outer plates 75D, and they does not slide each other. The both sides 77Ca, 77Cb of inner plates 77C are flattened without lubrication grooves.

The outer plates 75C, 75D allow lubrication grooves 87 to be limited to a necessary minimum.

[Fourth Embodiment]

The embodiment employs outer plates 75C, 75D as outer plates and inner plates 77A as inner plates. Both sides 77Aa, 77Ab of inner plates 77A and both sides 75Ca, 75Cb of intermediate outer plates 75C, and one side 75Da of outer plates 75D located at both ends in FIG. 7, have lubrication grooves 85, 87 formed thereon. The sides each slide against the neighboring plate to form sliding faces. The formation of lubrication grooves 85, 87 allows hydraulic lubrication for smooth rotation.

On the other hand, the opposite sides 75Db of outer plates 75D are formed without lubrication grooves. One opposite side 75Db faces rotor 31. The other opposite side 75Db faces armature 53.

The outer plates 75D, or a clutch plate, rotate integrally with armature 53 and rotor 31, with one side 75Db not sliding against armature 53 and rotor 31. Thus, lubrication grooves for hydraulic lubrication are unnecessary.

The contact area between outer plate 75D and rotor 31, or armature 53 is enlarged. The enlargement enhances magnetic permeability, thus improving the attraction force of electromagnet 51, thus increasing the engagement force of pilot clutch 19. The result is the increased engagement force of primary clutch 11, thus allowing stable power transmission.

No forming lubrication grooves on a side 75Db of outer plate 75D allows rotor 31 and outer plate 75D not to rub together when rotor 31 screws into housing 3, thus preventing the surface of rotor 31 from damage.

Side 75Db of one of both outer plates 75D may be formed with lubrication grooves. This improves magnetic permeability, thus allowing the engagement force of pilot clutch 19 to increase.

[Fifth Embodiment]

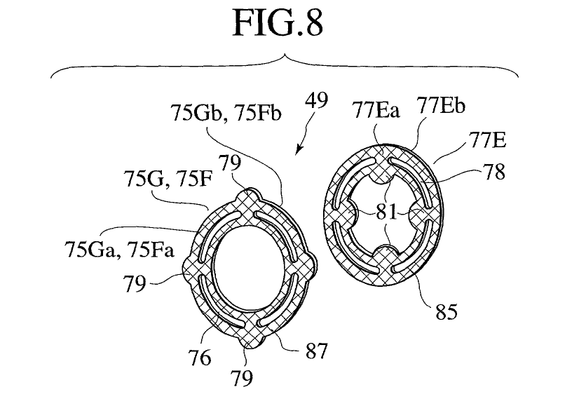

The embodiment will be described with reference to FIG. 8. The embodiment has pilot clutch 19 with sliding sides that are surface treated. Regarding the surface treatment, clutch plates are gas or salt-bath nitrided. The surface treatment allows the surfaces of the clutch plates to be hardened. This hardening improves the efficiency of friction, sliding ability and durability of the sliding sides of the clutch plates.

The surface treatment is applied to both sides 77Ea, 77Eb of all inner plates 77E, both sides 75Fa, 75Fb of the intermediate outer plates 75F, and the sides 75Ga of both end outer plates 75G, and not to the opposite sides 75Gb.

The outer plates 75G, or a clutch plate, rotate integrally with armature 53 and rotor 31, with the sides 75Gb not sliding on armature 53 and rotor 31. This does not need improved friction efficiency, and surface treatment is unnecessary

Without surface treatment to the sides 75Gb of outer plates 75G, the dispersion and interruption of magnetic flux does not occur due to the treatment layer. This improves magnetic permeability. The improvement of magnetic permeability allows the attraction force of electromagnet 51 to increase. This increases the engagement force of pilot clutch 19. The result increases the engagement force of primary clutch 11, thus allowing stable power transmission.

Side 75Gb of one of both outer plates 75G may be formed with a surface treatment. This improves magnetic permeability, thus allowing the engagement force of pilot clutch 19 to increase.

The entire contents of Japanese Patent Applications P2001-194892 (filed on Jun. 27, 2001) and P2001-64752 (filed on Mar. 8, 2001) are incorporated herein by reference.

While preferred embodiments of the present invention have been described using specific terms, such description is for illustrative purposes, and it is to be understood that changes and variations may be made without departing from the spirit or scope of the following claims.

What is claimed is:

1. An electromagnetic wet clutch system comprising:
operation members configured to magnetically work;
a set of clutch plates configured to engage by the operation members,
the set of clutch plates comprising:
first plates having first sides, respective one of the first sides being configured to contact respective one of the operation members, at least one of the first sides being boundary-lubricative.

2. The electromagnetic wet clutch system according to claim 1,
wherein the set of clutch plates comprises a second plate disposed between the first plates, the second plate including inner and outer peripheries defining a second side therebetween, the second side defining a hydraulic passage extending between the inner and outer peripheries.

3. The electromagnetic wet clutch system according to claim 2,
wherein the second plate includes a boundary-lubricative second opposite side relative to the second side.

4. The electromagnetic wet clutch system according to claim 2,
wherein the second plate includes a second opposite side relative to the second side, the second opposite side defining a hydraulic passage.

5. The electromagnetic wet clutch system according to claim 2,
wherein the hydraulic passage extends radially.

6. The electromagnetic wet clutch system according to claim 1,
wherein a first plate with a boundary-lubricative first side is configured to rotate integrally with an operation member.

7. The electromagnetic wet clutch system according to claim 6,
wherein the first plate and the operation member connect to a common spline.

8. The electromagnetic wet clutch system according to claim 1,
wherein the set of clutch plates includes a pair of sides sliding each other, one of said pair of sides including a hydraulic passage, another of said pair of sides being boundary-lubricative.

9. The electromagnetic wet clutch system according to claim 1,
wherein the set of clutch plates is disposed between inner and outer rotary members, the inner and outer rotary members having a fluid sealed therebetween for lubricating the set of clutch plates.
